(19) United States
(12) Patent Application Publication
(10) Pub. No.: US 2025/0336174 A1
(43) Pub. Date: Oct. 30, 2025

(54) METHOD AND APPARATUS FOR ANALYSING STREET IMAGES OR SATELLITE IMAGES OF LOCATIONS INTENDED TO BE USED FOR PLACEMENT OF ONE OR MORE PARCEL LOCKERS

(71) Applicant: SwipBox Development ApS, Sønderborg (DK)

(72) Inventor: Allan KACZMAREK, Sønderborg (DK)

(21) Appl. No.: 18/866,146

(22) PCT Filed: May 16, 2023
(86) PCT No.: PCT/DK2023/050119

§ 371 Date: Nov. 15, 2024

(30) Foreign Application Priority Data
May 16, 2022 (EP) 22173602.8

(51) Int. Cl. G06V 10/25; G06T 7/70; G06V 10/82; G06V 20/10; G06V 20/13

(52) U.S. Cl. CPC G06V 10/25; G06T 7/70; G06V 10/82; G06V 20/13; G06V 20/176; G06T 2207/10032; G06T 2207/20084

(57) ABSTRACT

A computer-implemented method for analyzing street images or satellite images of locations intended to be used for placement of one or more parcel lockers is provided, the method including steps of i) obtaining a number of street images or a number of satellite images of a number of locations, ii) determining a placement rating for parcel placement at the locations by processing each of the number of street images or each of the number of satellite images by a first trained data driven model, where the number of street images or the number of satellite images are fed as a digital input to the first trained data driven model and where the first trained data driven model provides a placement rating of the locations as a first digital output for further evaluation.

### CROSS-REFERENCE TO RELATED APPLICATIONS

This application is a national stage of PCT Application No. PCT/DK2023/050119, having a filing date of May 16, 2023, which is based on EP Application Serial No. 22173602.8, having a filing date of May 16, 2022, the entire contents both of which are hereby incorporated by reference.

### FIELD OF TECHNOLOGY

The following relates to a computer-implemented method and an apparatus for analyzing of street images or satellite images of locations intended to be used for placement of one or more parcel lockers.

The following also relates to a method for installing one or more parcel lockers which includes feeding the apparatus a number of street images or a number of satellite images of a number of locations as a digital input.

### BACKGROUND

There is an ever-increasing need for parcel handling and last mile solutions due to increases in E-commerce. One of the last mile solutions are parcel lockers, which are installed at various locations such as at stores or at filling stations or at other locations.

Parcel lockers cannot be placed at any random locations, for example the parcel locker should not be placed on grass as this will be a stability issue and preferably the parcel is placed up against a wall as this will decrease the risk of wind toppling the parcel locker. This is especially a problem for parcel lockers which are not anchored to the ground by additional means.

Anchoring is time-consuming and thus unwanted as it will increase installation costs significantly.

At the moment, the needed preparation before installation of a plurality of parcel lockers is by far the most time consuming as it requires location inspection, where inspectors visit 10 or 100 or 1,000 or 10,000 locations for review and selection. Some parcel lockers can be installed in 5-10 minutes however finding the location may take weeks or months depending on number of needed inspections.

Thus, there is a need for faster evaluation of possible locations such that the location inspection time can be reduced significantly.

### SUMMARY

An aspect relates to reducing the time needed for inspecting locations.

An aspect relates to a computer-implemented method for analyzing street images or satellite images of locations intended to be used for placement of one or more parcel lockers. In embodiments, the method comprises steps of
i) obtaining a number of street images or a number of satellite images of a number of locations,
ii) determining a placement rating for parcel placement at the locations by processing each of the number of street images or each of the number of satellite images by a first trained data driven model, where the number of street images or the number of satellite images is fed as a digital input to the first trained data driven model and where the first trained data driven model provides a placement rating of the locations as a first digital output for further evaluation.

The number of street images may be one, two, five, 10, 100, 500, 1,000, 10,000 or more street images. The street images may be images provided by Google Street View or other street images taken by third party. The images may be taken by camera systems from Immersive media or other camera systems. The street images from smart phones may be used in the method.

The number of satellite images may be one, two, five, 10, 100, 500, 1,000, 10,000 or more satellite images.

The term satellite images should be interpreted broadly in embodiments of the present invention as it may also include aerial images or drone images. The drone images and the aerial images and the satellite images are top down or vertical images, whereas street images are more horizontal images.

However, the drone images may be taken at heights and angles such that the drone images are mix between vertical images and horizontal images.

In most cases the first trained data driven model will typically be trained on training data comprising either street images or satellite images annotated with a placement rating. However, in embodiments the first trained data driven model may be trained on both street images and satellite images. In the case where the first trained data driven model is trained on street images and satellite images, then the street images and satellite images may be of the same areas such that street images and satellite images can be paired.

Presently, there are many parcel lockers in various locations, these locations are known and in many cases the parcel lockers of the locations can be seen in street images such as Google Street View. Thus, it is possible to use these locations and Google Street View as data for training the first trained data driven model.

The street images may include data from Google's Immersive view or similar solutions as the immersive view will include data related to relative heights between various objects in a street image.

The output from the method is a placement rating of the locations as a first digital output for further evaluation. Thereby, the method can provide an evaluation of each location based on the data feed. This will reduce the need for physical inspection as described in the Background of the Invention. A large contribution to the time reduction is that not suitable locations are given a low placement rating, which in essence means that the locations with low placement rating is removed from further evaluation, while locations with a high placement rating can be evaluated first further increasing the efficiency.

A user controls the threshold value for the placement rating, this may be dynamically changed depending on the number of needed locations and the number of potential locations, which has been fed to the first trained data driven model, and the resulting placement rating.

The further evaluation may be a user manually reviewing the street images or satellite images with a placement rating above a threshold value. The user may change the placement rating for various reasons.

The user may in embodiments or cases single out a number of the locations for physical inspection. This number of the locations for physical inspection may be reduced by 50% to 90% compared to conventional art solutions where each location fed to the first trained data driven model must be inspected. It is important to note, that the method will give direct locations while the conventional art solution was to physically scout, which involved driving up and down streets. Thus, even if the method provided 100 locations which all have to be inspected on-site then this would still be faster than the conventional art as a person may drive directly to the different locations to be inspected. However, the method will reduce the number of locations which will need to be inspected on-site, thus the effect is much greater.

The user may in embodiments or cases single out a number of the locations for direct installation without physical inspection, which is possible for some locations, and this will further reduce the time needed for choosing the locations for installations.

In embodiments, the number of street images or the number of satellite images may be a sequence of images of the same locations and the sequence may be fed as a digital input to the first trained data driven model.

In an aspect, embodiments of the method may comprise the following step prior to step ii): a) determining objects and object positions in the street images or the satellite images by processing each of the number of street images or each of the number of satellite images by a second trained data driven model, where the number of street images or the number of satellite images is fed as a digital input to the second trained data driven model and where the second trained data driven model provides the objects and the object positions as a second digital output, wherein the second digital output is fed the first trained data driven model as a digital input.

In step a) objects and object positions in the street images or the satellite images are determined using a second trained data driven model. The objects and object positions may be objects such as areas of grass or pavement or brick wall or bike rack or parking lot and so on which are relevant for the placement of the parcel locker. In embodiments, the parcel locker may be placed on pavement up against a wall as this will provide protection against wind gusts or high wind speeds.

The second trained data driven model may be trained by training data comprising a plurality of street images and/or satellite images being annotated with information, which annotated information may be areas of grass or pavement or brick wall or bike rack or parking lot and so. The cited list is not exhaustive.

In embodiments of the method, where the second trained data driven model, required that the first trained data driven model is trained on the training data comprising a plurality of street images and/or satellite images being annotated with information from manual annotation and/or from the second trained data driven model.

The determination of objects and object positions further improves the placement rating of the digital output of the first trained data driven model.

In embodiments, the object position of a determined object is defined in a given coordinate system and/or a given relation information defining a distance relative to other object positions of other determined objects. The given coordinate system may be an arbitrary coordinate system.

The location of the respective street image and/or satellite image is known thus a distance between the different determined object can be determined.

In an aspect, embodiments of the method may comprise after step ii) a step of
iii) calculating a parcel locker capacity of each of the number of street images or each of the number of satellite images having a placement rating above a threshold rating; and, optionally
iv) modifying the placement rating as a function of the parcel locker capacity.

The step of calculating may be performed using rule-based algorithms or using a third trained data driven model, wherein street images and/or satellite images of a location optionally annotated objects and object positions being fed as a third digital input to the third trained data driven model, wherein the third trained data driven model provides a parcel locker capacity of the location as a third digital output for further evaluation.

In theory, the calculating step could be performed for every single location regardless of the threshold rating, however this would be inefficient. Thus, the threshold rating or threshold in value is used for setting a lower bar again if 100 locations are needed, then there is no need to find the parcel locker capacity for +1000 locations.

The parcel locker capacity will typically be the maximum amount of parcel lockers which can be placed side by side continuously or at least semi-continuously with a minimal distance. One could imagine that a parking lot may have several separate positions which could be used for parcel lockers, however the parcel lockers should be placed side by side otherwise the parcel collection will be confusing for a user.

The parcel locker capacity i.e., number of parcel lockers that can be placed side by side depends on the dimensions and shape of the parcel lockers to be used.

Any known data driven model being learned by machine learning may be used in embodiments of the method.

In an aspect, the first trained data driven model and/or the second trained data driven model may be a neural network or a deep learning network such as a Convolutional Neural Network or Transformer network.

Deep learning networks are a method of machine learning in which an input, like image data, is processed through 5, 10, 25 or 100s of hidden layers to produce an output, for example a classification. The hidden layers comprise many millions or billions of trainable units/neurons, which are learned by a backpropagation algorithm, such as gradient descent. Deep learning may be performed supervised or unsupervised or a combination of the two.

Convolutional Neural Network is suitable for processing image data such as street images and/or satellite images. The transformer architecture may be suitable for processing sequences of image data originating from one or several street images and/or satellite images.

In an aspect, the second trained data driven model may be based on semantic segmentation.

Semantic segmentation is an excellent solution for identifying objects in images such as areas with pavement and areas with gras or dirt and so on.

In embodiments, parcel lockers should not be placed on grass or the like as grass is too unstable for a parcel locker, which may be placed for 5 to 10 years in embodiments. This is most relevant where the parcel locker is positioned on a precast foundation for fast and efficient installation. There are examples of parcel lockers where a foundation is cast on-site and in this case the foundation will replace the grass area i.e. the cast foundation becomes equivalent to a pavement or the like.

Semantic segmentation is a process assigning a class label to every pixel in an image on a per-pixel classification basis while maintaining separation between different objects and background in the image. Semantic segmentation may be the output of a deep learning model.

In an aspect, the first digital output and the locations may be output via a user interface.

Thereby, the first digital output and the locations can be evaluated manually by a user or person. The user will not need to go through each of the number of street images or the number of satellite images since the first digital output is a placement rating of the locations thus the user reviews the highest scoring locations and selects a sub-number of locations on which parcel lockers should be installed.

Some of the sub-number of locations may be flagged for manual inspection, other locations may be flagged for installation without further evaluation as a function of the user's review.

In an aspect, the one or more parcel lockers are battery-powered parcel lockers, wherein the first trained data driven model is trained for determining placement rating for battery-powered parcel lockers.

The complexity of the step of determination of the placement rating is significantly reduced by the parcel lockers being battery-powered parcel lockers, while the presession of the determined placement rating is increased. If the parcel locker is not battery powered then the parcel locker must be hardwired with power, however in many cases it is hard to determine from a street image or satellite image if it is possible within reasonable means to provide power to a specific parcel placement.

Installation is also an important parameter when setting up parcel lockers and a battery-powered parcel locker can be installed in roughly 5 minutes, since there is no need for hard-wire power and at the same time the battery-powered parcel lockers improve the efficiency of the computer implemented method. This is also why the information regarding the one or more parcel lockers are battery-powered parcel lockers is fed as a digital input to the first trained data driven model.

In an aspect, the one or more battery-powered parcel lockers comprises a pre-cast foundation, wherein the first trained data driven model is trained for determining placement rating for battery-powered parcel lockers with pre-cast foundation.

The pre-cast foundation further improves the versatility of the one or more battery-powered parcel lockers as the pre-cast foundation makes the one or more battery-powered parcel lockers mechanically more stable.

In an aspect, embodiments of the method may comprise the following step on each of the number of street images or of each of the number of satellite images having a placement rating above a threshold rating:
a) determining objects and object positions in the street images or the satellite images by processing each of the number of street images or each of the number of satellite images by a second trained data driven model, where the number of street images or the number of satellite images are fed as a digital input to the second trained data driven model and where the second trained data driven model provides the objects and the object positions as a second digital output, wherein the second digital output is applied as an image overlay to the street images 10 or the satellite images 20 for further evaluation.

In embodiments, this step is performed after step ii) and thus the purpose of the step is not to improve the determining a placement rating for parcel placement as such. However, the object and object positions can still be used during the further evaluation where a user may more quickly evaluate the street images or satellite images. Furthermore, the digital data regarding objects and the object positions may still be used in the calculating step.

However, it is more efficient to only evaluate the number of street images or of each of the number of satellite images having a placement rating above a threshold rating as it is expected that there will be many bad locations and/or simply bad images which cannot be used for evaluation. A street image may be blocked by a truck or something similar.

An aspect relates to an apparatus for computer-implemented analysis of street images or satellite images of locations intended to be used for placement of one or more parcel lockers. The apparatus comprises a processor configured to perform the following steps:
i) obtaining a number of street images and/or a number of satellite images of a number of locations,
ii) determining a placement rating for parcel placement at the locations by processing each of the number of street images or each of the number of satellite images by a first trained data driven model, where the number of street images or the number of satellite images are fed as a digital input to the first trained data driven model and where the first trained data driven model provides a placement rating of the locations as a first digital output for further evaluation.

Thereby, the apparatus can perform the previously described computer-implemented method, and the various different embodiments of the method described earlier in the present application.

In an aspect, the apparatus may be further configured to perform one or more of the previously described embodiments of the method for computer-implemented analysis of street images or satellite images of locations intended to be used for placement of one or more parcel lockers.

An aspect relates to a computer program product (non-transitory computer readable storage medium having instructions, which when executed by a processor, perform actions) comprising instructions which, when the program is executed by a computer, cause the computer to carry out the previously described embodiments of the method. The computer may be the apparatus.

An aspect relates to a computer-readable data carrier having stored thereon the computer program product.

An aspect relates to embodiments of a method for installing one or more parcel lockers in a selected area. In embodiments, the method comprises the steps of
providing an apparatus as previously described,
feeding the apparatus a number of street images or a number of satellite images of a number of locations in a selected area as a digital input;
receiving a placement rating of the locations as a first digital output from the apparatus;
reviewing a subset of the number of street images or the number of satellite images of the locations as a function of the placement rating;
selecting a number of locations of the reviewed subset of the locations for installation of one or more parcel lockers; and
installing one or more parcel lockers at one or more of the number of locations.

Thereby, the installation of the one or more parcel lockers in a selected area is greatly enhanced as the apparatus is able to remove unsuited locations from further review while locations which are determined to have a high placement rating are reviewed first by a user.

This will greatly increase the installation efficiency in the selected area as the need for manually inspection is reduced significantly and may in certain situations be eliminated. The installation efficient improvement for off grid parcel lockers such as battery-powered parcel lockers as the installation time of a battery-powered parcel locker is roughly 5 minutes. Thus, the limiting factor for installation of battery-powered parcel locker is location scouting which can take weeks or months depending on the number of locations which must be inspected.

The step of reviewing may be performed on a user interface.

In an aspect, the step of reviewing may include discarding locations, wherein data regarding the discarded locations is stored and used for improving the first trained data driven model.

Thereby, the first trained data driven model will improve as a function of the data.

In an aspect, the step of reviewing includes manually updating the parcel locker capacity.

The user may often be able to estimate or correct an estimation of the parcel locker capacity by simply reviewing the images. This is especially true for street images where objects in the images such as cars or windows or persons will enable a user to estimate the parcel locker capacity and in case of a mismatch then manually updating the parcel locker capacity.

### BRIEF DESCRIPTION

Some of the embodiments will be described in detail, with references to the following Figures, wherein like designations denote like members, wherein:

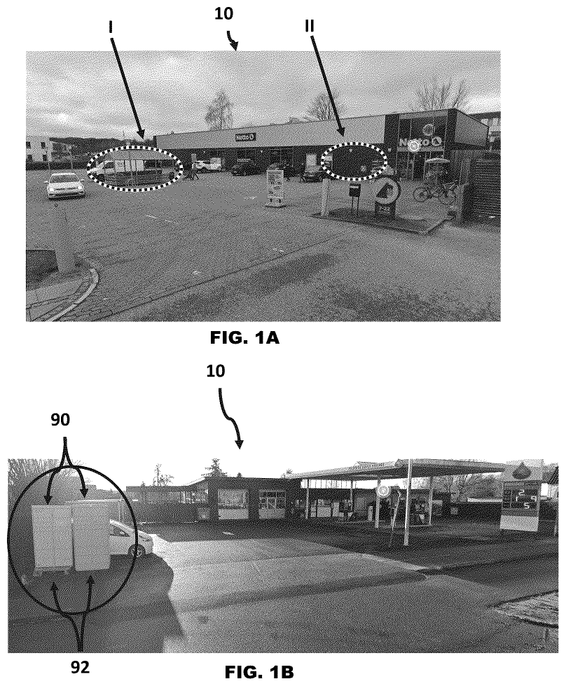

FIG. 1A depicts a street image of a first location;

FIG. 1B depicts a street image of a second location;

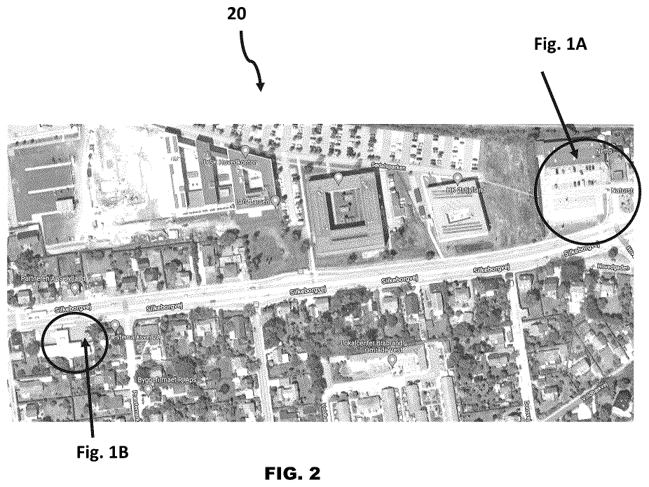

FIG. 2 depicts a satellite image showing the first location from FIG. 1A and the second location from FIG. 1B;

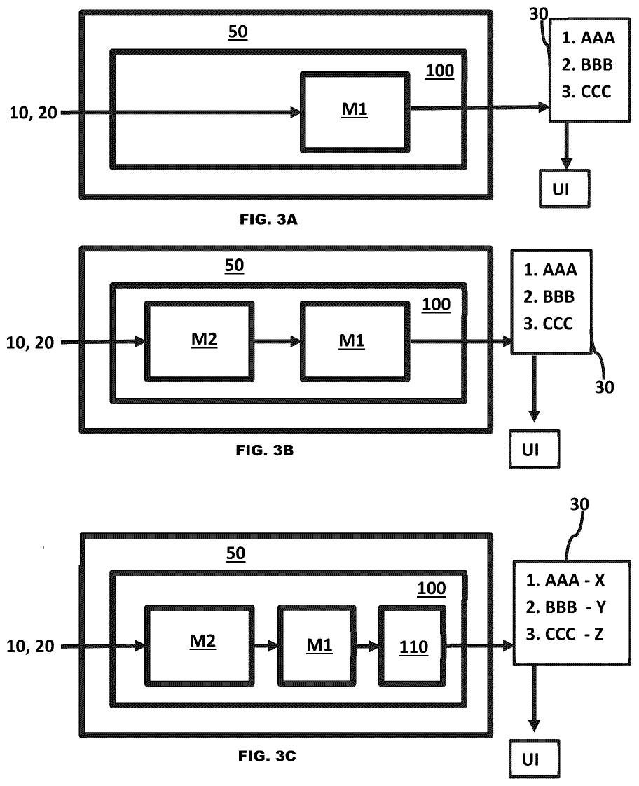

FIG. 3A depicts an embodiment of an apparatus performing the computer-implemented method;

FIG. 3B depicts a further embodiment of an apparatus performing the computer-implemented method;

FIG. 3C depicts a further embodiment of an apparatus performing the computer-implemented method;

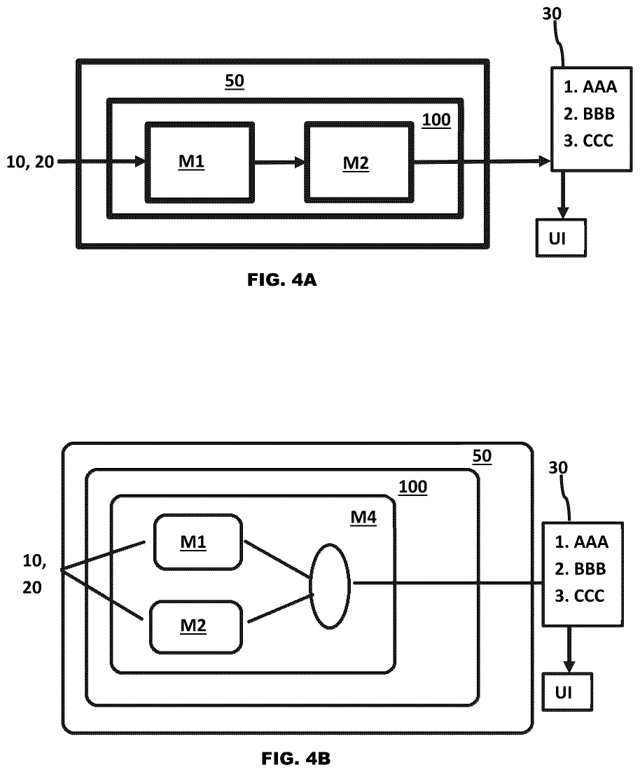

FIG. 4A depicts another embodiment of an apparatus performing the computer-implemented method; and

FIG. 4B depicts a further embodiment of an apparatus performing the computer-implemented method.

### LIST OF REFERENCE NUMBERS

| Item | No |
|---|---|
| First trained data driven model | M1 |
| Second trained data driven model | M2 |
| Third trained data driven model | M3 |
| Fourth trained data driven model | M4 |
| Street image | 10 |
| Satellite image | 20 |
| Placement rating | 30 |
| User interface | UI |
| Apparatus | 50 |
| Parcel locker | 90 |
| Pre-cast foundation | 92 |
| A computer-implemented method for analyzing of street | 100 |
| images or satellite images of locations intended to | |
| be used for placement of one or more parcel lockers | |
| Step of calculating parcel locker capacity | 110 |

### DETAILED DESCRIPTION

FIGS. 1A and 1B illustrate a street image 10 of two different locations (1A, 1B). The street images 10 is in this case provided by Google Street View.

FIG. 1A discloses a parking lot and a store. The method according to embodiments of the invention should give this location a high placement score as there are several positions which could be used for placement of one or more parcel lockers 90 (not shown). Two of these positions are marked by two circles denoted I and II.

On further review, which may be a manual review, a user should identify that position II is not suitable as it is actually a handicap spot. However, depending on the quality of the street image 10 this may only be identified upon manual inspection.

FIG. 1B discloses a filling station with two parcel lockers 92 on precast foundations. The location was found by location scouting and the position was selected. However, as the figure clearly shows, the same location could have been identified by analyzing a street image 10 such as this street image 10 from Google Street View.

Embodiments of the present invention are not limited to Google Street View.

FIG. 2 illustrates a satellite image 20 of the two different locations in FIGS. 1A and 1B. The shown area is of Brabrand in Denmark. The satellite image 20 discloses the areas of FIG. 1A and FIG. 1B for a top view. The parking lot of FIG. 1A is clearly viewable and the method should provide a high placement rating 30 (not shown in this figure) for FIG. 1A. However, the satellite image 20 is a top view and it will not be possible to identify the previous mentioned handicap spot of position II.

The computer-implemented method would be able to evaluate 1000s of street images 10 or satellite images 20 and provide a placement rating 30 of the locations as a first digital output for further evaluation by a user.

FIGS. 3A-3C illustrate three embodiments (3A, 3B, 3C) of an apparatus 50 performing the computer-implemented method 100.

The first embodiment in FIG. 3A discloses an apparatus 50 for computer-implemented analysis of street images 10 and/or satellite images 20 of locations intended to be used for placement of one or more parcel lockers 90, wherein the apparatus 50 comprises a processor configured to perform the method 100 comprising the steps of
i) obtaining a number of street images 10 or a number of satellite images 20 of a number of locations,
ii) determining a placement rating for parcel placement at the locations by processing each of the number of street images 10 or each of the number of satellite images 20 by a first trained data driven model M1, where the number of street images 10 or the number of satellite images 20 are fed as a digital input to the first trained data driven model M1 and where the first trained data driven model M1 provides a placement rating 30 of the locations as a first digital output for further evaluation.

The placement rating 30 is shown as a list of each location weighted with the individual placement rating 30, however it may be provided in another way. The placement rating 30 and associated street images 10 or satellite images 20 may be displayed in a user interface UI.

The second embodiment in FIG. 3B discloses an embodiment similar to the apparatus 50 shown in FIG. 3A. The difference is that the method 100 comprises the following step prior to step ii):
a) determining objects and object positions in the street images 10 or the satellite images 20 by processing each of the number of street images 10 or each of the number of satellite images 20 by a second trained data driven model M2, where the number of street images 10 or the number of satellite images 20 are fed as a digital input to the second trained data driven model M2 and where the second trained data driven model M2 provides the objects and the object positions as a second digital output, wherein the second digital output is fed the first trained data driven model M1 as a digital input.

The placement rating 30 is shown as a list, however it may be provided in another way. The placement rating 30 and associated street images 10 or satellite images 20 may be displayed in a user interface UI. Furthermore, the objects and object positions may likewise be displayed in the user interface together with the other digital data.

The third embodiment in FIG. 3C discloses an embodiment similar to the apparatus 50 shown in FIG. 3A or 3B. The third embodiment is shown to include the second trained data driven model M2, however the second trained data driven model M2 is optional.

The third embodiment in FIG. 3C, wherein the method 100 further comprises after step ii) a step of
iii) calculating 110 a parcel locker capacity of each of the number of street images 10 or of each of the number of satellite images 20 having a placement rating 30 above a threshold rating; and optionally
iv) modifying the placement rating 30 as a function of the parcel locker capacity.

The placement rating 30 is shown as a list, however it may be provided in another way. The placement rating 30 may be a modified placement rating 30. The placement rating 30, parcel locker capacity and associated street images 10 or satellite images 20 may be displayed in a user interface UI. Furthermore, the objects and object positions may likewise be displayed in the user interface together with the other digital data. The act of calculating may include a third data driving model M3, which is not in FIG. 3C.

FIG. 4A illustrates an embodiment of an apparatus 50 performing the computer-implemented method 100.

The embodiment in FIG. 4A discloses an embodiment similar to the apparatus 50 shown in FIG. 3A. The difference is that the method 100 comprises the following step on each of the number of street images 10 or of each of the number of satellite images 20 having a placement rating 30 above a threshold rating:
a) determining objects and object positions in the street images 10 or the satellite images 20 by processing each of the number of street images 10 or each of the number of satellite images 20 by a second trained data driven model M2, where the number of street images 10 or the number of satellite images 20 are fed as a digital input to the second trained data driven model M2 and where the second trained data driven model M2 provides the objects and the object positions as a second digital output, wherein the second digital output is applied as an image overlay to the street images 10 or the satellite images 20 for further evaluation. The image overlay will be visible on the user interface and will assist further manual evaluation.

FIG. 4B illustrates another embodiment of an apparatus 50 performing the computer-implemented method 100. The method 100 uses a fusion-based approach, wherein the features generated from the first trained data driven model M1 and the second trained data driven model M2 are concatenated and used as input to a fourth data driven model M4. The outputs of M1 and M2 are the last hidden layer and not the classification output as previously described in embodiments of the present invention and denoted first and second data output. These last hidden layer of M1 and M2 are input to a neural network illustrated in FIG. 4B as the oval shape, wherein the digital output of the fourth data driven model M4 is a placement rating 30 of each of the locations for further evaluation.

The first trained data driven model M1 and the second trained data driven model M2 may be according to anyone of the previously described embodiments.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A computer-implemented method for analyzing street images or satellite images of locations intended to be used for placement of one or more parcel lockers, the method comprising:
i) obtaining a number of street images or a number of satellite images of a number of locations,
ii) determining a placement rating for parcel placement at the locations by processing each of the number of street images or each of the number of satellite images by a first trained data driven model, where the number of street images or the number of satellite images are fed as a digital input to the first trained data driven model and where the first trained data driven model-provides a placement rating of the locations as a first digital output for further evaluation.

2. The method according to claim 1, wherein the method comprises the following step prior to step ii):
a) determining objects and object positions in the street images or the satellite images by processing each of the number of street images or each of the number of satellite images by a second trained data driven model, where the number of street images or the number of satellite images are fed as a digital input to the second trained data driven model and where the second trained data driven model provides the objects and the object positions as a second digital output, wherein the second digital output is fed the first trained data driven model as a digital input.

3. The method according to claim 1, wherein the method comprises after step ii) a step of
iii) calculating a parcel locker capacity of each of the number of street images or of each of the number of satellite images having a placement rating above a threshold rating; and optionally
iv) modifying the placement rating as a function of the parcel locker capacity.

4. The method according to claim 1, wherein the first trained data driven model and/or the second trained data driven model is a neural network or deep learning such as a Convolutional Neural Network or Transformer network.

5. The method according to claim 2, wherein the second trained data driven model is based on semantic segmentation.

6. The method according to claim 1, wherein first digital output and the locations are output via a user interface.

7. The method according to claim 1, wherein the one or more parcel lockers are battery-powered parcel lockers, wherein the first trained data driven model is trained for determining placement rating for battery-powered parcel lockers.

8. The method according to claim 7, wherein the one or more battery-powered parcel lockers comprises a pre-cast foundation, wherein the first trained data driven model is trained for determining placement rating for battery-powered parcel lockers with the pre-cast foundation.

9. The method according to claim 1, wherein the method comprises the following step on each of the number of street images or of each of the number of satellite images having a placement rating above a threshold rating: a) determining objects and object positions in the street images or the satellite images by processing each of the number of street images or each of the number of satellite images by a second trained data driven model, where the number of street images or the number of satellite images are fed as a digital input to the second trained data driven model and where the second trained data driven model provides the objects and the object positions as a second digital output, wherein the second digital output is applied as an image overlay to the street images or the satellite images for further evaluation.

10. An apparatus for computer-implemented analysis of street images and/or satellite images of locations intended to be used for placement of one or more parcel lockers, wherein the apparatus comprises a processor configured to perform the following steps:
i) obtaining a number of street images or a number of satellite images of a number of locations,
ii) determining a placement rating for parcel placement at the locations by processing each of the number of street images or each of the number of satellite images by a first trained data driven model, where the number of street images or the number of satellite images is fed as a digital input to the first trained data driven model and where the first trained data driven model provides a placement rating of the locations as a first digital output for further evaluation.

11. The apparatus according to claim 10, wherein the processor is further configured to perform the following step prior to step ii):
a) determining objects and object positions in the street images or the satellite images by processing each of the number of street images or each of the number of satellite images by a second trained data driven model, where the number of street images or the number of satellite images are fed as a digital input to the second trained data driven model) and ere the second trained data driven model provides the objects and the object positions as a second digital output, wherein the second digital output is fed the first trained data driven model as a digital input, and/or wherein the processor is further configured to perform the following steps after step ii);
iii) calculating a parcel locker capacity of each of the number of street images or of each of the number of satellite ages having a placement rating above a threshold ting and optionally
iv) modifying the placement rating as a function of the parcel locker capacity.

12. A computer program product, comprising a computer readable hardware storage device having computer readable program code stored therein, said program code executable by a processor of a computer system to implement the method according to claim 1.

13. A computer-readable data carrier having stored thereon the computer program product of claim 12.

14. A method for installing one or more parcel lockers in a selected area, wherein the method comprises the steps of
providing an apparatus according to claim 10,
feeding the apparatus a number of street images or a number of satellite images of a number of locations within the selected area as a digital input;
receiving a placement rating of the locations as a first digital output from the apparatus;
reviewing a subset of the number of street images or the number of satellite images of the locations as a function of the placement rating;
selecting a number of locations of the reviewed subset of the locations for installation of one or more parcel lockers; and
installing one or more parcel lockers at one or more of the number of locations.

15. The method according to claim 14, wherein the step of reviewing includes discarding locations, wherein data regarding the discarded locations is stored and used for improving the first trained data driven model.

16. The method according to claim 14, wherein the step of reviewing includes manually updating the parcel locker capacity.
